(19) United States
(12) Patent Application Publication
(10) Pub. No.: US 2008/0214632 A1
(43) Pub. Date: Sep. 4, 2008

(54) Parasiticidal Compositions

(75) Inventors: Hans-Dieter Hamel, Koln (DE); Josef Heine, Leichlingen (DE); Christoph Hubo, Odenthal (DE); Wolfgang Jiritschka, Leichlingen (DE); Dirk Mertin, Langenfeld (DE)

Correspondence Address: BAYER HEALTHCARE LLC, P.O.BOX 390, SHAWNEE MISSION, KS, 66201, US

(73) Assignee: BAYER HEALTHCARE AG, Leverkusen (DE)

(21) Appl. No.: 10/593,537

(22) PCT Filed: Mar. 5, 2005
(86) PCT No.: PCT/EP2005/002331

§ 371 Date: Aug. 6, 2007

(30) Foreign Application Priority Data
Mar. 19, 2004 (DE) 10 2004 013 527.4

(51) Int. Cl. A01N 43/78; A01N 43/22; A01N 37/52; A01P 15/00

(52) U.S. Cl. 514/370; 514/450; 514/636

(57) ABSTRACT

The present invention relates to products comprising a macrocylic lactone and an amidine, which products are suitable for controlling parasites, in particular ectoparasites, on animals.

The present invention relates to products comprising a macrocyclic lactone and an amidine, which products are suitable for controlling parasites, in particular ectoparasites, on animals.

Macrocyclic lactones are, in particular in veterinary medicine, known as agents having both excellent endoparasiticidal action and, within certain limits, also ectoparasiticidal action.

Amidines, such as, for example, amitraz or cymiazole, are likewise already known as insecticides/acaricides.

However, when used against ectoparasites, the active compounds of these two classes of substances have, when applied externally, certain disadvantages, such as insufficient activity or side-effects. It would be desirable to have virtually 100% activity at a dosage which is as low as possible, to reduce side-effects.

Surprisingly, it has been found that, when macrocyclic lactones and amidines are used in combination, the ectoparasiticidal action is, in an unexpected manner, enhanced compared to the single preparations. It is thus possible to achieve good ectoparasiticidal activity at low dosages. In addition, in the case of a combined use, the compatibility is improved significantly.

Accordingly, the invention relates to products comprising a macrocyclic lactone and an amidine.

For the purpose of this invention, macrocyclic lactones are in particular avermectins, 22,23-dihydroavermectins B₁ (ivermectins) or milbemycins.

Avermectins were isolated as microbial metabolites from the microorganism Streptomyces avermitilis (U.S. Pat. No. 4,310,519) and may essentially occur as a mixture comprising the eight components A₁ₐ, A_{1b}, A₂ₐ, A_{2b}, B₁ₐ, B_{1b}, B₂ₐ and B_{2b} (I. Putter et al. Experentia 37 (1981) p. 963, Birkhäuser Verlag (Switzerland)). In addition, the synthetic derivatives, in particular 22,23-dihydroavermectin B₁ (ivermectin), are also of interest (U.S. Pat. No. 4,199,569). It is also possible to isolate milbemycin B-41 D from Streptomyces hygroscopicus by fermentation (cf. “Milbemycin: Discovery and Development” I. Junya et al. Annu. Rep. Sankyo Res. Lab. 45 (1993), pp. 1-98; JP-Pat. 8 378 549; GB 1 390 336).

The use of avermectins, 22,23-dihydroavermectins B₁ (ivermectins) and milbemycins from the class of the macrocyclic lactones as endoparasiticides has been known for a long time and is the subject of numerous patent applications and review articles (for example biological actions in: “Ivermectin and Abamectin” W. C. Campbell, Ed., Springer Verlag, New York, N.Y., 1989; “Avermectins and Milbemycins Part II” H. G. Davies et al. Chem. Soc. Rev. 20 (1991) pp. 271-339; chemical modifications in: G. Lukacs et al. (Eds.), Springer-Verlag, New York, (1990), Chapter 3; Cydectin™ [moxidectin and derivatives]: G. T. Carter et al. J. Chem. Soc. Chem. Commun. (1987), pp. 402-404); EP 423 445-A1). The use of doramectin (Pfizer) as an endoparasiticide is also known (cf. “Doramectin—a potent novel endectozide” A. C. Goudie et al. Vet. Parasitol. 49 (1993), pp. 5-15).

The avermectins are compounds or compound mixtures of lactone macrolides of the general formula (I)

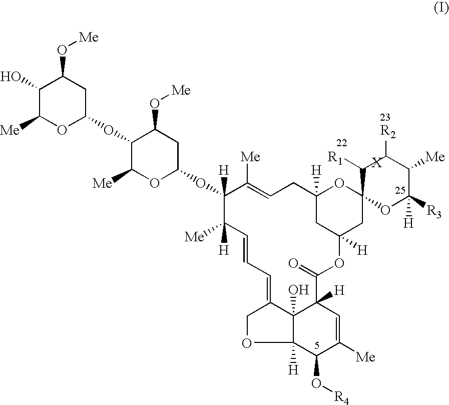

in which
the radicals R¹ to R⁴ are as defined in Table 1 below and X may represent a single or double bond between the C₂₂- and C₂₃-position (—C₂₂R¹—X—C₂₃R²—).

In the case of a double bond, there are no substituents (R¹, R²) on the C₂₂- and C₂₃-positions.

TABLE 1

| Macrocyclic lactone | —C₂₂R¹—X—C₂₃R²— | R³ | R⁴ |
|---|---|---|---|
| avermectin A₁ₐ | —CH═CH— | -sec-Bu | -Me |
| avermectin A_{1b} | —CH═CH— | -iso-Pr | -Me |
| avermectin A₂ₐ | —CH₂—CHOH— | -sec-Bu | -Me |
| avermectin A_{2b} | —CH₂—CHOH— | -iso-Pr | -Me |
| avermectin B₁ₐ | —CH═CH— | -sec-Bu | —H |
| avermectin B_{1b} | —CH═CH— | -iso-Pr | —H |
| avermectin B₂ₐ | —CH₂—CHOH— | -sec-Bu | —H |
| avermectin B_{2b} | —CH₂—CHOH— | -iso-Pr | —H |
| 22,23-dihydroavermectin | —CH₂—CH₂— | -sec-Bu | —H |
| B₁ₐ | | | |
| 22,23-dihydroavermectin | —CH₂—CH₂— | -iso-Pr | —H |
| B_{1b} | | | |
| doramectin | —CH═CH— | -Chx | —H |

22,23-dihydroavermectin B₁ is ivermectin B₁;
sec-Bu = secondary butyl;
iso-Pr = isopropyl;
Chx = cyclohexyl;
-Me = methyl

The avermectins and 22,23-dihydroavermectins B₁ (ivermectins) of the general formula (I) are generally employed as mixtures. Of particular interest is here the product abamectin which comprises essentially the avermectins B₁ and their hydrogenation products, the 22,23-dihydroavermectins B₁ (ivermectin).

The compounds of the macrocyclic lactones having an isopropyl radical in the C₂₅-position, which compounds are referred to by “b”, do not necessarily have to be separated from the “a” compounds having a sec-butyl group in the C₂₅-position. It is generally the mixture of both substances comprising >80% by weight of sec-butyl derivative (B₁ₐ) and <20% by weight of iopropyl derivative (B_{1b}) which is isolated and which can be used according to the invention. Moreover, the substituents in the C₁₃- and C₂₃-positions of the stereoisomers may be located either in the α- or in the β-position on the ring system, i.e. above or below the molecular plane. In each case, all stereoisomers fall within the scope of the invention.

Milbemycins have the same macrolide ring structure as avermectins or 22,23-dihydro-avermectins B₁ (ivermectins) but do not carry any substituent (i.e. they lack the oleandrose disaccharide fragment) in position 13 (R⁵=hydrogen).

Milbemycins from the class of the macrocyclic lactones which may be mentioned by way of example are the compounds of the general formula (II)

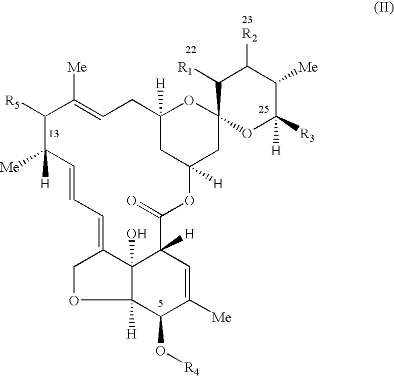

in which
the radicals R¹ to R⁵ are as defined in Table 2 below:

TABLE 2

| Macrocyclic lactone | R¹ | R² | R³ | R⁴ | R⁵ |
|---|---|---|---|---|---|
| milbemycin B41 D | —H | —H | —iso-Pr | —H | —H |
| nemadectin | —H | —OH | 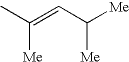 | —H | —H |
| moxidectin | —H | ═N—O—Me | 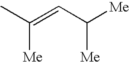 | —H | —H |

iso-Pr = isopropyl

From among the compounds of the formulae (I) and (II), the following macrocyclic lactones are of particular interest according to the invention:

avermectin B₁ₐ/B_{1b} (or abamectin)

22,23-dihydroavermectin B₁ₐ/B_{1b} (or ivermectin B₁ₐ/B_{1b})

doramectin

moxidectin

In the literature, a 4:1 mixture of avermectin B₁ₐ and avermectin B_{1b} is referred to as abamectin. According to the invention, abamectin is used with very particular preference.

For the purpose of this invention, amidines are to be understood as amidine compounds having an arthropodicidal action. This is a class well known to the person skilled in the art. Typical amidines are cymiazole

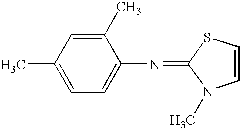

and amitraz:

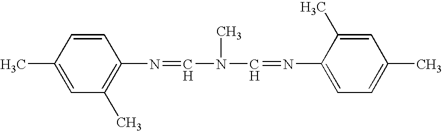

For the purpose of the invention, the active compounds are, if applicable, understood to include their pharmaceutically acceptable salts, hydrates and prodrugs.

The compositions according to the invention are suitable for controlling parasites, in particular ectoparasites, such as arthropods, preferably insects and arachnids, encountered in animal husbandry and livestock breeding, in productive livestock, breeding stock and pets. They are active against all or some stages of development of the pests and against resistant and normally sensitive species of the pests.

By controlling the animal pests, it is intended to prevent diseases and their transmission, mortality and decreasing performance (for example in the production of meat, milk, hides, eggs), so that more economical and simpler animal keeping is possible, or so that in certain areas animal keeping is possible at all, by using the active compounds.

The pests include:

from the order of the Anoplura, for example, Haematopinus spp., Linognathus spp., Solenopotes spp.,
from the order of the Diptera, for example, Haematobia spp.,
from the order of the Metastigmata, for example, Hyalomma spp., Rhipicephalus spp., Boophilus spp., Amblyomma spp., Haemophysalis spp., Dermacentor spp., Ixodes spp., Argas spp., Ornithodorus spp., Otobius spp.,
from the order of the Mesostigmata, for example, Dermanyssus spp., Ornithonyssus spp., Pneumonyssus spp.,
from the order of the Prostigmata, for example, Demodex spp.,
from the order of the Astigmata, for example, Psoroptes spp., Chorioptes spp., Otodectes spp., Sarcoptes spp., Notoedres spp., Knemidocoptes spp., Neoknemidocoptex spp.

The products according to the invention are preferably employed against Boophilus spp., in particular Boophilus microplus.

The domestic animals and productive livestock include mammals, such as, for example, cattle, sheep, goats, horses, pigs, dogs, cats, camels, water buffalo, birds, such as, for example, chickens.

The pets include dogs and cats.

The products are preferably applied to dogs, horses, sheep, goats and in the breeding of game; particular preference is given to application on productive livestock, in particular cattle.

Application can be carried out both prophylactically and therapeutically.

The active compounds are applied directly or in the form of suitable preparations, usually by external application.

External application is, for example, by dipping, spraying, bathing, washing, pouring-on and spotting-on, rubbing-in and powdering.

Suitable preparations are: solutions, for example solutions for use on the skin or in body cavities, pour-on formulations, gels; emulsions and suspensions, semi-solid preparations; solid preparations, such as, for example, powders, premixes or concentrates, granules.

Solutions for use on the skin are applied drop by drop, smoothed on, rubbed in, splashed on or sprayed on, or applied by dipping, bathing or washing. These solutions are prepared by dissolving the active compound in a suitable solvent and adding, if required, additives such as solubilizers, acids, bases, buffer salts, antioxidants, preservatives; sterile processing is not required here.

Solvents which may be mentioned are: physiolocially acceptable solvents, such as water, alcohols, such as ethanol, butanol, benzyl alcohol, glycerol, hydrocarbons, propylene glycol, polyethylene glycols, N-methylpyrrolidone, and mixtures of these.

If appropriate, the active compounds may also be dissolved in physiologically acceptable, pharmaceutically suitable vegetable or synthetic oils.

Solubilizers which may be mentioned are: solvents which facilitate the dissolution of the active compound in the main solvent or which prevent precipitation of the active compound. Examples are polyvinylpyrrolidone, polyethoxylated castor oil, polyethoxylated sorbitan esters.

Preservatives are: benzyl alcohol, trichlorobutanol, p-hydroxybenzoic esters, n-butanol.

It may be advantageous to add thickeners in the preparation process. Thickeners are: inorganic thickeners, such as bentonites, colloidal silica, aluminium monostearate, or organic thickeners, such as cellulose derivatives, polyvinyl alcohols and their copolymers, acrylates and methacrylates.

Gels are applied to the skin or smoothed on or introduced into body cavities. Gels are prepared by adding such an amount of thickener to solutions which have been prepared as described above, that a clear composition is formed which has an ointment-like consistency. The thickeners used are the thickeners indicated further above.

Pour-on and spot-on formulations are poured or splashed onto limited areas of the skin, the active compound either penetrating the skin and acting systemically or distributing itself over the surface of the body.

Pour-on and spot-on formulations are prepared by dissolving, suspending or emulsifying the active compound in suitable solvents or solvent mixtures which are tolerated by the skin. If appropriate, other auxiliaries, such as colorants, bioabsorption promoters, antioxidants, photostabilizers or tackifiers are added.

Solvents which may be mentioned are: water, alkanols, such as ethanol, isopropanol, 2-hexyldecanol, octyldodecanol and tetrahydrofurfuryl alcohol, glycols, such as glycerol, propylene glycol, polyethylene-glycols, polypropylene glycols, aromatic alcohols, such as benzyl alcohol, phenylethanol, phenoxyethanol, esters, such as ethyl acetate, butyl acetate, benzyl benzoate, dibutyl adipate, dicaprylyl carbonate, diethylhexyl carbonate, propylene carbonate, ethers, such as dicaprylyl ether, alkylene glycol alkyl ethers, such as dipropylene glycol monomethyl ether, diethylene glycol monoethyl ether, ketones, such as acetone, methyl ethyl ketone, methyl isobutyl ketone, aromatic and/or aliphatic hydrocarbons, vegetable or synthetic fatty oils, such as peanut oil, olive oil, rapeseed oil, sesame oil, soya bean oil, sunflower oil, glyceryl ricinoleate, medium-chain triglycerides, propylene glycol dicaprylate/dicaprate, propylene glycol dipelargonate and propylene glycol laurate; other fatty acid esters, such as 2-octyldodecyl myristate, cetearyl isononanoate, cetearyl octanoate, cetylethyl hexanoate, coco caprylate/caprate, decyl cocoate, decyl oleate, ethyl oleate, isocetyl palmitate, isopropyl myristate, isopropyl palmitate, isostearyl isostearate, octyl palmitate, octyl stearate, oleyl erucate; silicone oils, such as cetyl dimethicone, dimethicone and simethicone; dimethylformamide, dimethylacetamide, glycerol formal, glycofurol, 2-pyrrolidone, N-methylpyrrolidone, 2-dimethyl-4-hydroxymethylene-1,3-dioxolane or dioctylcyclohexane.

Colorants are all colorants which can be dissolved or suspended and which are approved for use in animals.

Examples of bioabsorption promoters are DMSO, spreading oils, such as isopropyl myristate, isopropyl palmitate, dipropylene glycol pelargonate, silicone oils, fatty acid esters, triglycerides or fatty alcohols.

Antioxidants are sulphites or metabisulphites, such as potassium metabisulphite, ascorbic acid, butylated hydroxytoluene, butylated hydroxyanisole or tocopherol.

Examples of photostabilizers are substances from the class of the benzophenones or novantisolic acid.

Tackifiers are, for example, cellulose derivatives, starch derivatives, polyacrylates or natural polymers such as alginates or gelatin.

Emulsions are either the water-in-oil type or the oil-in-water type.

They are prepared by dissolving the active compound either in the hydrophobic or in the hydrophilic phase and by homogenizing this phase with the solvent of the other phase, with the aid of suitable emulsifiers and, if appropriate, other auxiliaries, such as colorants, bioabsorption promoters, preservatives, antioxidants, photostabilizers, and viscosity-increasing substances.

Suitable hydrophobic phases (oils) include: paraffin oils, silicone oils, natural vegetable oils such as sesame seed oil, almond oil or castor oil, synthetic triglycerides, such as caprylic/capric acid triglyceride, a triglyceride mixture with vegetable fatty acids of chain length C₈₋₁₂ or other specifically selected natural fatty acids, mixtures of partial glycerides of saturated or unsaturated fatty acids which may also contain hydroxyl groups, and mono- and diglycerides of the C₈/C₁₀-fatty acids.

Fatty acid esters, such as ethyl stearate, di-n-butyryl adipate, hexyl laurate, dipropylene glycol pelargonate, esters of a branched fatty acid having a medium chain length with saturated fatty alcohols of chain length C₁₆-C₁₈, isopropyl myristate, isopropyl palmitate, caprylic/capric esters of saturated fatty alcohols of chain length C₁₂-C₁₈, isopropyl stearate, oleyl oleate, decyl oleate, ethyl oleate, ethyl lactate, waxy fatty acid esters such as artificial duck uropygial fat, dibutyl phthalate, diisopropyl adipate, ester mixtures related to the latter, etc.

Fatty alcohols, such as isotridecyl alcohol, 2-octyldodecanol, cetylstearyl alcohol or oleyl alcohol.

Fatty acids, such as, for example, oleic acid and its mixtures.

Suitable hydrophilic phases include: water, alcohols, such as, for example, ethanol, isopropanol, propylene glycol, glycerol, sorbitol and their mixtures.

Suitable emulsifiers include: nonionic surfactants, for example polyethoxylated castor oil, polyethoxylated sorbitan monooleate, sorbitan monostearate, glycerol monostearate, polyethoxy stearate or alkylphenol polyglycol ethers;

ampholytic surfactants, such as disodium N-lauryl-β-iminodipropionate or lecithin;
anionic surfactants, such as Na lauryl sulphate, fatty alcohol ether sulphates, and the monoethanolamine salt of mono/dialkylpolyglycol ether orthophosphoric ester; cationic surfactants, such as cetyltrimethylammonium chloride.

Other suitable auxiliaries include: substances which increase the viscosity and stabilize the emulsion, such as carboxymethylcellulose, methylcellulose and other cellulose and starch derivatives, polyacrylates, alginates, gelatin, gum arabic, polyvinyl-pyrrolidone, polyvinyl alcohol, methylvinyl ether/maleic anhydride copolymers, polyethylene glycols, waxes, colloidal silica, or mixtures of the listed substances.

Suspensions are prepared by suspending the active compound in a liquid excipient, if appropriate with the addition of other auxiliaries, such as wetting agents, colorants, bioabsorption promoters, preservatives, stabilizers, antioxidants and photostabilizers.

Suitable liquid excipients include all homogeneous solvents and solvent mixtures.

Suitable wetting agents (dispersants) include the surfactants indicated further above.

Suitable other auxiliaries include those indicated further above.

Semi-solid preparations differ from the above-described suspensions and emulsions only in their higher viscosity.

To prepare solid preparations, the active compound is mixed with suitable carriers, if appropriate with the addition of auxiliaries, and the mixture is formulated as desired.

Suitable carriers include all physiologically acceptable solid inert substances. Suitable for this purpose are inorganic and organic substances. Inorganic substances are, for example, common salt, carbonates, such as calcium carbonate, hydrogen carbonates, aluminium oxides, silicas, clays, precipitated or colloidal silica, and phosphates.

Organic substances are, for example, sugars, cellulose, foodstuffs and animal feeds, such as powdered milk, animal meals, cereal meals, coarse cereal meals and starches.

Auxiliaries are preservatives, antioxidants, stabilizers and colorants which have already been mentioned further above.

Other suitable auxiliaries are lubricants and glidants, such as, for example, magnesium stearate, stearic acid, talc, bentonites, disintegrants, such as starch or crosslinked polyvinylpyrrolidone, binders, such as, for example, starch, gelatin or linear polyvinyl-pyrrolidone, and dry binders, such as microcrystalline cellulose.

In the preparations, the active compounds can also be present in mixtures with synergists or other active compounds.

Ready-to-use preparations comprise the active compounds in each case in concentrations of from 10 ppm to 25% by weight; the macrocyclic lactone is preferably employed in concentrations of from 0.01 to 5% by weight, particularly preferably from 0.1 to 2% by weight; the amidine is preferably employed in concentrations of from 1 to 20% by weight, particularly preferably 5 to 15% by weight.

Preparations which are diluted before use comprise the active compounds in each case in concentrations of from 0.5 to 90% by weight, preferably from 5 to 50% by weight.

In general, it has been found to be advantageous to administer amounts of about 0.01 to 100 mg of active compound per kg of bodyweight per day to obtain effective results; for the macrocyclic lactone, preferred customary daily doses are in the range from 0.05 to 5 mg/kg, preferably from 0.1 to 3 mg/kg; for the amidine, customary daily doses are preferably in the range from 1 to 30 mg/kg, particularly preferably from 5 to 15 mg/kg.

Particular preference according to the invention is given to pour-on or spot-on formulations. Such formulations comprise the macrocyclic lactone in amounts of from 0.01 to 10% by weight, preferably from 0.1 to 1% by weight.

The amidine content is usually from 0.5 to 25% by weight, preferably from 5 to 15% by weight.

Suitable solvents for the pour-on or spot-on formulations are the solvents mentioned above.

Preference is given here to solvents which have very good solubilizing properties for macrocyclic lactones and amidines, such as ethanol, isopropanol, propylene glycol, 2-hexyldecanol, octyldodecanol, dibutyl adipate, medium-chain triglycerides, propylene glycol dicaprylate/dicaprate, propylene glycol laurate, isopropyl myristate, isopropyl palmitate, propylene carbonate, dipropylene glycol monomethyl ether, diethylene glycol monoethyl ether and ketones.

Preference is also given to solvents having good spreading properties, such as 2-hexyldecanol, octyldodecanol, 2-octyldodecyl myristate, cetearyl isononanoate, cetearyl octanoate, cetyl ethylhexanoate, coco caprylate/caprate, decyl cocoate, decyl oleate, ethyl oleate, isocetyl palmitate, isopropyl myristate, isopropyl palmitate, isostearyl isostearate, octyl palmitate, octyl stearate, oleyl erucate, medium-chain triglycerides, propylene glycol dicaprylate/dicaprate, dipropylene glycol monomethyl ether, diethylene glycol monoethyl ether, cetyl dimethicone, dimethicone and simethicone.

Particular preference is given here to solvents having good solubilizing properties for macrocyclic lactones and amidines and good spreading properties, such as 2-hexyldecanol, octyldodecanol, dibutyl adipate, dipropylene glycol monomethyl ether, diethylene glycolmonoethyl ether, medium-chain triglycerides, propylene glycol dicaprylate/dicaprate, propyleneglycol laurate, isopropyl myristate and isopropyl palmitate.

The solvents can be used alone or else in combination. Their total concentration is usually between 10 and 98% by weight, preferably between 30 and 95% by weight.

In addition, the preferred spot-on or pour-on formulations may comprise customary pharmaceutical additives and auxiliaries. Preference is given to adding, for stabilizing the active compounds, basic substances, such as ammonia, sodium hydroxide or triethanolamine, usually in concentrations of from 0.1 to 3% by weight, preferably from 0.1 to 2% by weight.

According to a preferred embodiment, the solvents used for the compositions according to the invention are mixtures of an alkanol having 1 to 4 carbon atoms, for example ethanol or, in particular, isopropanol, with an aliphatic fatty acid ester, in particular a fatty acid ester of an aliphatic C₁₋₄-alcohol unit with a C₁₂₋₁₈-fatty acid, for example ethyl oleate, isopropyl myristate or isopropyl palmitate, and paraffin oil, in particular low-viscosity paraffin oil. With particular preference, the mixtures comprise these three components in each case in the same proportions by weight. As already indicated above, it is advantageous, if appropriate, to add a base such as triethanolamine to this solvent mixture.

Spot-on or pour-on formulations can also be formulated as emulsion concentrates. In this case, a higher concentration of the active compounds is dissolved in a solvent together with a dispersant. The user adds a certain amount of this concentrate to water, resulting, spontaneously or after shaking, in the formation of an emulsion. The solvents used can be the substances mentioned above, and the dispersants used can be the ionic and non-ionic emulsifiers likewise mentioned above.

Combined use means that the amidines and macrocyclic lactones can be used either separately or successively. In this case, the amidines and macrocyclic lactones are each formulated as separate medicaments. Simultaneous use is also feasible; according to the invention, amidine and macrocyclic lactone are preferably formulated together in a composition.

Suitable examples of formulations of the active compound combination to be used according to the invention are given below; this does not limit the invention in any way.

### EXAMPLES

In the examples, the amounts used are stated in grams per 100 millilitres of finished preparation.

### Example 1

| | |
|---|---|
| 0.5 g | of abamectin |
| 10 g | of cymiazole |
| 40 g | of medium-chain triglycerides (MKT, Miglyol 812) |
| 40 g | of isopropyl myristate |

MKT and isopropyl myristate are mixed and heated to about 50° C. Abamectin and cymiazole are dissolved successively in the mixture. A slightly turbid yellowish solution is obtained.

### Example 2

| | |
|---|---|
| 0.5 g | of abamectin |
| 5 g | of cymiazole |
| 43 g | of medium-chain triglycerides (MKT, Miglyol 812) |
| 43 g | of isopropyl myristate |

### Preparation see Example 1

### Example 3

| | |
|---|---|
| 0.5 g | of abamectin |
| 10 g | of cymiazole |
| 0.5 g | of triethanolamine |
| 25 g | of isopropyl myristate |
| 25 g | of isopropanol |
| 25 g | of low-viscosity paraffin |

Abamectin, triethanolamine and cymiazole are dissolved successively in isopropanol. Isopropyl myristate and low-viscosity paraffin are then added. A yellowish solution is formed.

### Example 4

| | |
|---|---|
| 0.5 g | of abamectin |
| 5 g | of cymiazole |
| 0.5 g | of triethanolamine |
| 26 g | of isopropyl myristate |
| 26 g | of isopropanol |
| 26 g | of low-viscosity paraffin |

### Preparation see Example 3

### Example 5

| | |
|---|---|
| 0.5 g | of abamectin |
| 10 g | of cymiazole |
| 86 g | of dibutyl adipate (Cetiol B) |

With heating to 50° C., abamectin and cymiazole are dissolved successively in dibutyl adipate. A yellowish solution is formed.

### Example 6

| | |
|---|---|
| 0.5 g | of abamectin |
| 10 g | of cymiazole |
| 82 g | of propylene glycol laurate (Lauroglycol FCC) |

With heating to 50° C., abamectin and cymiazole are dissolved successively in propylene glycol laurate. A yellowish solution is formed.

### Example 7

| | |
|---|---|
| 0.5 g | of abamectin |
| 10 g | of cymiazole |
| 25 g | of isopropyl palmitate |
| 25 g | of isopropanol |
| 25 g | of low-viscosity paraffin |

Abamectin and cymiazole are dissolved successively in isopropanol. Isopropyl palmitate and low-viscosity paraffin are then added. A yellowish solution is formed.

### Example 8

| | |
|---|---|
| 0.5 g | of abamectin |
| 10 g | of cymiazole |
| 71 g | of isopropanol |

Abamectin and cymiazole are dissolved successively in isopropanol. A yellowish solution is formed.

### Example 9

| | |
|---|---|
| 0.5 g | of abamectin |
| 10 g | of cymiazole |
| 0.5 g | of cysteamine |
| 40 g | of isopropyl palmitate |
| 40 g | of propylene glycol laurate |

With heating to 50° C., abamectin, cysteamine and cymiazole are dissolved successively in propylene glycol laurate. Isopropyl palmitate is then added. A yellowish solution is formed.

### Example 10

| | |
|---|---|
| 0.5 g | of abamectin |
| 10 g | of cymiazole |
| 0.05 g | of butylated hydroxytoluene (BHT) |
| 40 g | of isopropyl palmitate |
| 40 g | of propylene glycol laurate |

With heating to 50° C., abamectin, BHT and cymiazole are dissolved successively in the mixture of isopropyl palmitate and propylene glycol laurate. A yellowish solution is formed.

### Example 11

| | |
|---|---|
| 0.5 g | of abamectin |
| 10 g | of cymiazole |
| 40 g | of soya bean oil |
| 40 g | of isopropyl palmitate |

With heating to 50° C., abamectin and cymiazole are dissolved successively in the mixture of soya bean oil and isopropyl palmitate. A turbid yellow-brown solution is formed.

### Example 12

| | |
|---|---|
| 1.5 g | of abamectin |
| 30 g | of cymiazole |
| 10 g | of PEG-35 castor oil (Cremophor EL) |
| 56 g | of propylene glycol laurate (Lauroglycol FCC) |

With heating to 50° C., abamectin and cymiazole are dissolved successively in propylene glycol laurate. PEG-35 castor oil is then added. A slightly turbid yellow-brown solution is formed. One part of this solution and two parts of water give a ready-to-use pour-on emulsion.

### Example 13

| | |
|---|---|
| 1.5 g | of abamectin |
| 30 g | of cymiazole |
| 10 g | of PEG-40 hydrogenated castor oil (Emulgin HRE 40) |
| 56 g | of propylene glycol laurate (Lauroglycol FCC) |

With heating to 50° C., abamectin and cymiazole are dissolved successively in propylene glycol laurate. PEG-40 hydrogenated castor oil is then added. A slightly turbid yellow-brown solution (emulsion concentrate) is formed. One part of this solution and two parts of water give a ready-to-use pour-on emulsion.

### Example 14

| | |
|---|---|
| 1.5 g | of abamectin |
| 30 g | of cymiazole |
| 10 g | of polysorbate 80 (Tween 80) |
| 25 g | of methyl isobutyl ketone |
| 25 g | of isopropyl myristate |

With heating to 50° C., abamectin and cymiazole are dissolved successively in the mixture of methyl isobutyl ketone and isopropyl myristate. Polysorbate 80 is then added. A turbid yellow-brown solution is formed. One part of this solution and two parts of water give a ready-to-use pour-on emulsion.

### Example 15

| | |
|---|---|
| 1.5 g | of abamectin |
| 30 g | of cymiazole |
| 10 g | of polysorbate 60 (Crillet 3 Super) |
| 25 g | of methyl isobutyl ketone |
| 25 g | of isopropyl myristate |

With heating to 50° C., abamectin and cymiazole are dissolved successively in the mixture of methyl isobutyl ketone and isopropyl myristate. Polysorbate 60 is then added. A turbid yellow-brown solution is formed. One part of this solution and two parts of water give a ready-to-use pour-on emulsion.

### Example 16

| | |
|---|---|
| 0.5 g | of ivermectin |
| 10 g | of cymiazole |
| 0.5 g | of triethanolamine |
| 25 g | of isopropyl palmitate |
| 25 g | of isopropanol |
| 25 g | of low-viscosity paraffin |

Ivermectin, triethanolamine and cymiazole are dissolved successively in isopropanol. Isopropyl palmitate and low-viscosity paraffin are then added. A yellowish solution is formed.

### Example 17

| | |
|---|---|
| 0.5 g | of moxidectin |
| 10 g | of cymiazole |
| 25 g | of isopropyl palmitate |
| 25 g | of isopropanol |
| 25 g | of medium-chain triglycerides (MKT, Miglyol 812) |

Moxidectin and cymiazole are dissolved successively in isopropanol. Isopropyl palmitate and medium-chain triglycerides are then added. A yellowish solution is formed.

### Example 18

| | |
|---|---|
| 0.5 g | of abamectin |
| 10 g | of amitraz |
| 0.5 g | of triethanolamine |
| 25 g | of isopropyl myristate |
| 25 g | of acetone |
| 25 g | of low-viscosity paraffin |

Abamectin, triethanolamine and amitraz are dissolved successively in isopropanol. Isopropyl myristate and low-viscosity paraffin are then added. A yellowish solution is formed.

### Example 19

| | |
|---|---|
| 0.33 g | of abamectin |
| 6.67 g | of cymiazole |
| 0.5 g | of triethanolamine |
| 25.7 g | of isopropyl myristate |
| 25.7 g | of isopropanol |
| 25.7 g | of low-viscosity paraffin |

Abamectin, triethanolamine and cymiazole are dissolved successively in isopropanol. Isopropyl myristate and low-viscosity paraffin are then added. A yellowish solution is formed.

### Example 20

| | |
|---|---|
| 0.5 g | of abamectin |
| 10 g | of cymiazole |
| 0.5 g | of triethanolamine |
| 25 g | of isopropyl palmitate |
| 25 g | of isopropanol |
| 25 g | of low-viscosity paraffin |

Abamectin, triethanolamine and cymiazole are dissolved successively in isopropanol. Isopropyl palmitate and low-viscosity paraffin are then added. A yellowish solution is formed.

### Biological Example

### In Vivo Test on Cattle with Boophilus microplus

Prior to the start of the experiment, cattle were kept in individual stables for two weeks. After the adaptation phase, each cattle was, on days −24, −21, −19, −17, −14, −12, −10, −7, −5, −3 and −1, infested with 5000 larvae (0.25 g) of Boophilus microplus (collected in the field) of an age of 7 to 21 days. Day zero was the treatment day. On days −3 to day 51 after the treatment, ticks which had sucked themselves full were collected.

Based on the average number of collected Boophilus microplus females collected on days −3, −2 and −1, the animals were grouped and divided into blocks, the number of which corresponded to the number of test groups. Within the blocks, the cattle were assigned on a random basis to the individual test groups.

| | | |
|---|---|---|
| Group | Number of cattle | Treatment |

Test 1:

| | | |
|---|---|---|
| A | 5 | Control |
| B | 5 | Example 5 |
| C | 5 | Example 6 |
| D | 5 | Example 1 |
| E | 5 | Example 2 |

Test 2:

| | | |
|---|---|---|
| A | 5 | Example 3 |
| B | 5 | cymiazole mono #1 |
| C | 5 | cymiazole |
| | | mono #2 control |
| D | 5 | |
| E | 5 | cymiazole mono #3 |
| F | 5 | Example 2 |
| G | 5 | commercial abamectin |
| | | product |
| H | 5 | Example 1 |
| I | 5 | Example 4 |

Composition of the Comparative Cymiazole Monopreparations (Stated in % w/v):

Cymiazole mono #1

| | |
|---|---|
| Cymiazole | 10.0% |
| Triethanolamine | 0.5% |
| Isopropanol | 24.8% |
| Isopropyl myristate | 24.8% |
| Low-viscosity paraffin | 24.8% |

Cymiazole mono #2

| | |
|---|---|
| Cymiazole | 10.0% |
| Medium-chain triglycerides | 40.4% |
| Isopropyl myristate | 40.4% |

Cymiazole mono #3

| | |
|---|---|
| Cymiazole | 5.0% |
| Triethanolamine | 0.5% |
| Isopropanol | 26.1% |
| Isopropyl myristate | 26.1% |
| Low-viscosity paraffin | 26.1% |

The efficacy in percent for each treatment was calculated using the formula below:

$$Efficacy in percent = 1 - \frac{T a \times C b}{T b \times C a} \times 100$$

where:
Ta=average number of ticks collected from the treated animals after the treatment;
Tb=average number of ticks collected from the treated animals during the three days prior to the treatment;
Ca=average number of ticks collected from the control animals in the phase after the treatment;
Cb=average number of ticks collected from the control animals in the three days prior to the treatment.

The results are shown in the figures:

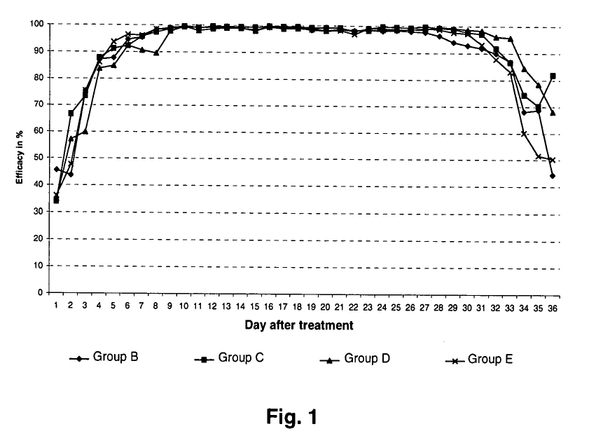

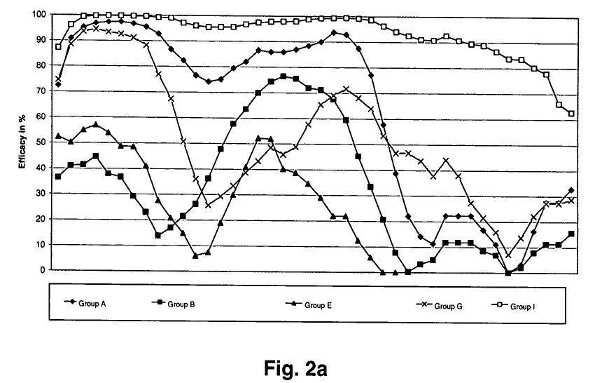

FIG. 1: Test 1: Efficacy in percent of cymiazole/abamectin against Boophilus microplus in experimentally infected cattle (arithmetic mean for day 1 to day 36)

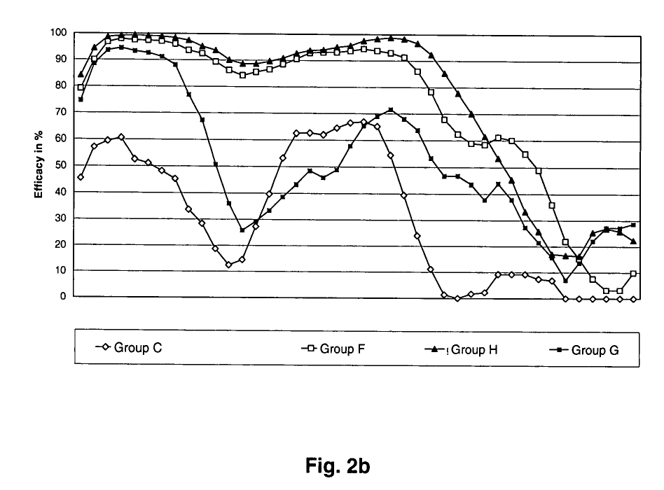

FIG. 2a: Test 2: Efficacy in percent of cymiazole/abamectin against Boophilus microplus in experimentally infected cattle (moving averages for day 3 to day 44)

FIG. 2b: Test 2: Efficacy in percent of cymiazole/abamectin against Boophilus microplus in experimentally infected cattle (moving averages for day 3 to day 44)

1. A product comprising a combination of a macrocyclic lactone and an amidine.

2. The product of claim 1 for the simultaneous, separate or successive use against parasites on animals.

3. The product of claim 1 wherein the macrocyclic lactone is abamectin.

4. The product of claim 1, wherein the amidine is amitraz and/or cymiazole.

5. The product of claim 1, wherein the macrocyclic lactone is abamectin and the amidine is cymiazole.

6. (canceled)

7. (canceled)

8. The product of claim 1 for application onto the coat of the animals.

9. The product of claim 1 for application as a spot-on or pour-on.

10. The product of claim 1 for application as a spot-on or pour-on after dilution with water.

11. (canceled)

12. (canceled)

13. A method for controlling parasites on animals, which method comprises applying to the animal an effective amount of a composition comprising a macrocyclic lactone in combination with an amidine.

14. The method of claim 13, wherein the composition is applied simultaneously, separately or successively.

15. The method of claim 13, wherein the macrocyclic lactone is abamectin.

16. The method of claim 13, wherein the amidine is amitraz and/or cymiazole.

17. The method of claim 13, wherein the macrocyclic lactone is abamectin and the amidine is cymiazole.

18. The method of claim 13, wherein said animal is productive livestock.

19. The method of claim 13, wherein said animal is cattle.

20. The method of claim 13, wherein the composition is applied to the coat of the animal.

21. The method of claim 13, wherein the composition is applied as a spot-on or pour-on.

22. The method of claim 13, wherein the composition is applied as a spot-on or pour-on after dilution with water.
